(19) United States
(12) Patent Application Publication
(10) Pub. No.: US 2024/0165623 A1
(43) Pub. Date: May 23, 2024

(54) SYSTEMS, DEVICES, AND METHODS OF HIGH-THROUGHPUT SCREENING OF MICROBIAL INTERACTIONS

(71) Applicant: Qatar Foundation for Education, Science and Community Development, Doha (QA)

(72) Inventors: Ali Sultan, Doha (QA); Sini Skariah, Doha (QA); Arum Han, Doha (QA); Adrian Guzman, Doha (QA)

(21) Appl. No.: 18/281,514

(22) PCT Filed: Mar. 11, 2022
(86) PCT No.: PCT/QA2022/050004

§ 371 Date: Sep. 11, 2023

Related U.S. Application Data
(60) Provisional application No. 63/159,783, filed on Mar. 11, 2021.

(51) Int. Cl. B01L 3/00; G01N 15/01; G01N 15/10

(52) U.S. Cl. CPC B01L 3/502784; B01L 3/502707; G01N 15/01; G01N 15/10; B01L 2200/0652; B01L 2200/0673; B01L 2200/10; B01L 2200/12; B01L 2300/12; G01N 2015/1028

(57) ABSTRACT

A method and an integrated device are provided for high-throughput screening of cellular libraries utilizing a droplet microfluidic-based approach. The integrated device comprises 8 or more major functionalities including droplet generation, droplet incubation, droplet reflow, droplet cleaving/generation, droplet synchronization, droplet merging, droplet detection, and droplet sorting for complex screening assays. Integration of each of the droplet functionalities onto a single chip reduces drastic changes in flow experienced at various chip-to-chip interfaces, and the possibility of error.

### CROSS REFERENCE TO RELATED APPLICATION

The present application claims priority to U.S. Provisional Patent Application No. 63/159,783, filed Mar. 11, 2021, the disclosure of which is incorporated into this specification by reference in its entirety.

### BACKGROUND

Microfluidic platforms are beginning to become widely accepted as efficient low-cost and high-throughput alternatives for conducting complex assays in a fraction of the time when compared to conventional assays. Droplet assays use a fraction of the reagents when compared to conventional bulk fluidic assays (e.g., robotic pipetting/liquid handling systems). In lieu of these facts, droplet microfluidic assays have been increasingly gaining interest as commercially viable tools for biopharmaceutical and biotechnology applications. The ability to conduct complex high-throughput single-cell resolution analyses at a fraction of the cost with enhanced sensitivity has the ability to revolutionize the compound/drug discovery industry, as an example.

Existing methods and systems have various drawbacks. For example, for polymerized cell encapsulation, e.g., encapsulation and polymerization of poly(N-isopropylacrylamide) (PNIPAM) microbeads that serve as hydrogel materials for cell cultivation, different cells require different stimuli to proliferate, and in some instances chemical treatment has been shown to have adverse effects on cells. In the case of environmental-based screening, this can reduce the number of hits recovered.

Finger-powered microfluidic systems using multilayer soft lithography and injection molding process use a series of normally closed valves in a precise manner to control all fluid movement in the device including droplet generation, reflow, waste, trapping, and hit recovery. For example, a three-layer process is typically used in the field to create membranes. The process can be similar to that of a peristaltic pump where actuation leads to movement of fluid within a device.

In continuous-flow microdroplets reaction and rupture systems, an angled pillar array is used to physically move droplets from one continuous phase to a different continuous phase where droplets are released back to conventional fluidics. Other similar methods have been utilized with reagents, electric fields, and acoustics to rupture droplets and convert droplets of interest for typical microfluidic manipulation. This method ruptures the droplet, cross-contamination between droplets can occur leading to inconsistent downstream processing and results. High-throughput screening systems require complete isolation of cells even after droplet recovery to minimize the amount of human handling and post-screening plating required to isolate hits for analysis. A series of valves can be used to automatically trap, release, and space droplets to be dispensed on plates while maintaining a single droplet format.

Gel encapsulation can include addition of agarose and adjustment of temperature to transition droplets from solid agarose to liquid. Typically, higher agarose percentages lead to more stable droplets that are identical bioreactors, but low percentages agarose droplets can still be sticky and when in close proximity can cause issues during culture. Droplets are temperature released and transferred to a continuous fluidic aqueous phase. Cross contamination can occur during this process, and in some cases high temperatures are needed to release cells which could decrease cell viability of target hits.

Co-flow systems can be used for droplet encapsulation with integration of the system with laser detection. This functionality has yet to be integrated into a comprehensive single chip screening system for ultra-high efficiency screening.

Single-layer chip and multi-chip methods can be used for generating, incubating, reflowing, detection, and sorting droplets. The methodology for employing the screening is substantially different than a fully-integrated multilayer platform. In the multi-chip format, tubing interfaces couple with culture chambers and planar devices, often leading to abrupt changes in the flow dynamics of droplets, resulting in droplet merging and splitting, which drastically reduces the downstream operation efficiency.

A multi-chip droplet screening approach can be utilized for screening. However, the processes are not automated, and these systems have not integrated all droplet functionalities (droplet generation, cultivation, detection, sorting, and hit recovery) onto a single chip. Therefore, many of these systems suffer from efficiency limitations and cannot achieve extremely high efficiency/automated screening processes.

Although many of the basic droplet microfluidic manipulation techniques have been reported in previous works, the current state of the art in the field does not have a method or means for integrating all components into a single chip for automated high-throughput processing. Current systems utilize multiple devices comprising separate droplet functionalities tethered by tubing in a sequential manner to accomplish droplet screening. These methods typically have a limitation in the maximum efficiency that can be obtain during screening, typically, around 95%.

### SUMMARY

The present disclosure provides systems, devices and methods for integrating, automating, and achieving ultra-high efficiency (above 99.9%) droplet screening.

In light of the present disclosure, and without limiting the scope of the disclosure in any way, in an aspect of the present disclosure, which may be combined with any other aspect listed herein unless specified otherwise, a droplet microfluidic platform is provided. The droplet microfluidic platform includes a plurality of substrate layers into which various functional components are fabricated into, the functional components including at least one co-flow based droplet generator for continuous generation of a cell or reagent-encapsulated droplets; at least one droplet incubation chamber for incubation of the cell or reagent-encapsulated droplets; at least one valve for trapping or releasing the droplets; a droplet detection mechanism; a sorting mechanism for sorting the droplets based on the detection result, and at least one droplet passage to interconnect the functional components. The droplet microfluidic platform is capable of continuous or semi-continuous on-chip operation of droplets in a first-in first-out manner.

In an aspect of the present disclosure, which may be combined with any other aspect listed herein unless specified otherwise, the droplet microfluidic platform further comprises a functional component for on-chip recovery of sorted droplets.

In an aspect of the present disclosure, which may be combined with any other aspect listed herein unless specified otherwise, the droplet detection mechanism is configured to detect at least one of optical, dielectric, conductivity, or vibrational spectroscopy signals.

In an aspect of the present disclosure, which may be combined with any other aspect listed herein unless specified otherwise, the substrate layers comprises 5 to 20 layers.

In an aspect of the present disclosure, which may be combined with any other aspect listed herein unless specified otherwise, the droplet microfluidic platform is fabricated as a single injection molded piece.

In an aspect of the present disclosure, which may be combined with any other aspect listed herein unless specified otherwise, the droplet microfluidic platform includes multiple injection molded pieces that are stacked and bonded together.

In an aspect of the present disclosure, which may be combined with any other aspect listed herein unless specified otherwise, the platform comprises a sandwich multiplexed design, and wherein at least two droplet incubation chambers are in the same horizontal plane.

In an aspect of the present disclosure, which may be combined with any other aspect listed herein unless specified otherwise, a method of making a droplet microfluidic platform is provided. The method comprises casting 5 to 20 individual polydimethylsiloxane (PDMS) layers from a master mold; bonding the individual polydimethylsiloxane layers into a single structure utilizing corresponding integrated alignment marks imbedded into each layer, the single structure comprising fluid passages and functional components between adjacent layers. The droplet microfluidic platform is capable of continuous or semi-continuous on-chip operation of droplets through a sequence of functional components in a first-in first-out manner.

In an aspect of the present disclosure, which may be combined with any other aspect listed herein unless specified otherwise, a method of making a droplet microfluidic platform is provided. The method comprises injection molding multiple layers of the platform as individual pieces; bonding the individual pieces into a single structure comprising fluid passages and functional components between adjacent layers. The droplet microfluidic platform is capable of continuous or semi-continuous on-chip operation of droplets through a sequence of functional components in a first-in first-out manner.

In an aspect of the present disclosure, which may be combined with any other aspect listed herein unless specified otherwise, a method of making a droplet microfluidic platform is provided. The method comprises injection molding the platform design into a single component. The droplet microfluidic platform is capable of continuous or semi-continuous on-chip operation of droplets through a sequence of functional components in a first-in first-out manner.

In an aspect of the present disclosure, which may be combined with any other aspect listed herein unless specified otherwise, a method for identifying cell-produced molecules affecting a target cell utilizing a droplet microfluidic platform is provided. The method comprises generating continuously a large number of cell-encapsulated droplets comprising a target cell and a library cell that is a potential producer of molecules capable of affecting the target cell; co-incubation of both cell types for a certain period of time for the production of molecules by the library cell to influence the target cell; analyzing the cell-encapsulated droplets using an on-chip detection mechanism; sorting the cell-encapsulated droplets that show effect of interest on the target cell; and recovering the sorted cell-encapsulated droplets of interest.

In an aspect of the present disclosure, which may be combined with any other aspect listed herein unless specified otherwise, on-chip analysis of the cell-encapsulated droplets is based on at least one of determining expression or function of a nucleic acid or protein; analyzing growth rate, death, necrosis or apoptosis of the target cell; and evaluating metabolic activity or production of metabolic products.

In an aspect of the present disclosure, which may be combined with any other aspect listed herein unless specified otherwise, on-chip analysis of cell-encapsulated droplets is based on at least one of fluorescent, colorimetric, dielectric, conductivity, or vibrational spectroscopy signals.

In an aspect of the present disclosure, which may be combined with any other aspect listed herein unless specified otherwise, at least one of the following is detected and sorted based on target cell death, reduction in target cell growth compared to normal growth, increase in target cell growth compared to normal growth, activation of nucleic acid expression, and suppression of nucleic acid expression, activation of protein expression, suppression of protein expression, activation of metabolic product expression, or suppression of metabolic product expression.

In an aspect of the present disclosure, which may be combined with any other aspect listed herein unless specified otherwise, the target cell comprises at least one selected from the group consisting of eukaryotic cells, bacterial cells, archaeal cells, pathogens, commensal organisms, microbes, mammalian cells, and insect cells.

In an aspect of the present disclosure, which may be combined with any other aspect listed herein unless specified otherwise, the synthetic libraries include a polyketide expression library.

In an aspect of the present disclosure, which may be combined with any other aspect listed herein unless specified otherwise, a multiplexed incubation chamber scheme is used.

In an aspect of the present disclosure, which may be combined with any other aspect listed herein unless specified otherwise, a multi-emulsion process is used to generate droplets including at least one of gel droplets, double emulsion, core-shell structures, multi-core-shell structures, particles, beads, reagents, biochemical compounds, or fluid phases.

In an aspect of the present disclosure, which may be combined with any other aspect listed herein unless specified otherwise, a gradient droplet generator is coupled to the droplet microfluidic platform to generate encapsulated droplets comprising a gradient of a compound or the target cell.

Additional features and advantages are described herein, and will be apparent from the following Detailed Description and the Figures.

### BRIEF DESCRIPTION OF THE FIGURES

Features and advantages of the systems, devices and methods for integrating, automating, and achieving ultra-high efficiency droplet screening as described herein may be better understood by reference to the accompanying drawing in which:

FIG. 1 is a 3D schematic illustration of an integrated droplet microfluidic platform according to an embodiment of the present disclosure.

FIG. 2A is a top view of the integrated droplet microfluidic platform according to an embodiment of the present disclosure; and FIG. 2B is a side view of the integrated droplet microfluidic platform according to an embodiment of the present disclosure.

FIG. 3 is a schematic workflow of a screening assay to be performed on the integrated droplet microfluidic platform according to an embodiment of the present disclosure.

FIG. 4 is a micrograph illustrating a Y-shape droplet generator for co-flow and a cross junction droplet generator for encapsulation of two fluids simultaneously according to an embodiment of the present disclosure.

FIG. 5A is a 2D schematic illustration of a large-scale culture chamber (top valve is closed) and operation principle; FIG. 5B is a 2D schematic illustration of a large-scale culture chamber (top valve is opened) and operation principle; FIG. 5C is a micrograph illustrating an integrated valve for control of flow into, through, and out of the culture chamber; and FIG. 5D is a micrograph illustrating droplets being reflowed in a packed controlled format for optimal downstream operation according to an embodiment of the present disclosure.

FIG. 6 is a micrograph illustrating an adjacent droplet spacer channel injecting oil into the system to space droplets before downstream processing according to an embodiment of the present disclosure.

FIG. 7 is a micrograph illustrating a detection region for on-the-fly whole droplet detection according to an embodiment of the present disclosure.

FIG. 8 is a micrograph illustrating a droplet sorting region where one outlet goes to waste, and an adjacent outlet is used to collect “hits” of interest according to an embodiment of the present disclosure.

FIG. 9A is a micrograph illustrating a waste basket for equal fluid resistance according to an embodiment of the present disclosure; and FIG. 9B is a micrograph illustrating a basket trapping structure to collect droplets of interest according to an embodiment of the present disclosure.

FIG. 10A is a schematic illustration of a process for automatic trapping of hit droplets; and FIG. 10B is a schematic illustration of a process for automatic release of hit droplets according to an embodiment of the present disclosure.

FIG. 11 is a schematic illustration of a core-shell droplet that can be generated using co-flow and multi-emulsion to include droplet merging without any separate merging functionalities according to an embodiment of the present disclosure.

FIG. 12 is a schematic illustration of a co-flow ratio gradient generator for screening of different concentrations or combination concentrations according to an embodiment of the present disclosure.

FIG. 13 is a schematic illustration of a triple flow scheme for including dye-staining with ability to include other quad- (or more) co-flow or multi-emulsion schemes for encapsulating multiple fluids according to an embodiment of the present disclosure

The reader will appreciate the foregoing details, as well as others, upon considering the following detailed description of certain non-limiting embodiments according to the present disclosure.

### DETAILED DESCRIPTION

The present disclosure provides systems, devices and methods for integrating, automating, and achieving ultra-high efficiency (above 99.9%) droplet screening.

The embodiments are described more fully hereinafter with reference to the accompanying drawings, in which some, but not all embodiments of the present technology are shown. Indeed, the present technology may be embodied in many different forms and should not be construed as limited to the embodiments set forth herein.

Likewise, many modifications and other embodiments of systems, devices and methods described herein will come to mind to one of skill in the art to which the present disclosure pertains having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

Throughout the specification and claims, terms may have nuanced meanings suggested or implied in context beyond an explicitly stated meaning. Likewise, the phrase “in an embodiment” as used herein does not necessarily refer to the same embodiment or implementation and the phrase “in another embodiment” as used herein does not necessarily refer to a different embodiment or implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The terminology used herein is for the purpose of describing particular example embodiments only and is not intended to be limiting. The terms “comprise”, “comprises”, “comprised” or “comprising”, “including” or “having” and the like in the present specification and claims are used in an inclusive sense, that is to specify the presence of the stated features but not preclude the presence of additional or further features.

The present disclosure provides a method/integrated device for high-throughput screening of cellular libraries utilizing a droplet microfluidic-based approach. The system may comprise 8 major functionalities (such as droplet generation, droplet incubation, droplet reflow, droplet cleaving/generation, droplet synchronization, droplet merging, droplet detection, and droplet sorting) for complex screening assays. Integration of each of the droplet functionalities onto a single chip reduces drastic changes in flow experienced at various chip-to-chip interfaces, reducing the possibility of error. Furthermore, full integration of all steps onto a single chip allows for the automation of all droplet processing steps, minimizing or removing the need for human intervention in the various steps, which further reduces the error rate of a given assay, maximizes the success rate of the system and provides an ultra-high efficiency (above 99.9%) screening system.

The present disclosure also provides an environmental library-based droplet screening approach, where environmental organisms are co-encapsulated with a Green Fluorescent Protein (GFP) target organism in a water-in-oil emulsion to probe their interactions and measure how the environmental cells affect the target organism. After co-incubation in a large-scale droplet culture chamber, droplets will be reflowed for downstream fluorescent-based detection, followed by electric field droplet sorting based on the observed interactions. Sorted “hit droplets” are trapped on-chip and reflowed using an automated droplet recovery process for post-processing of the “hit droplets.”

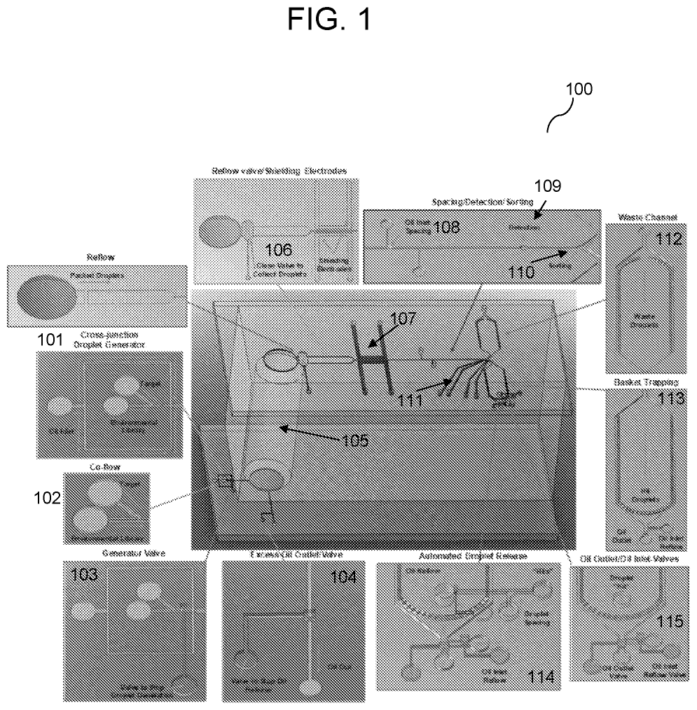

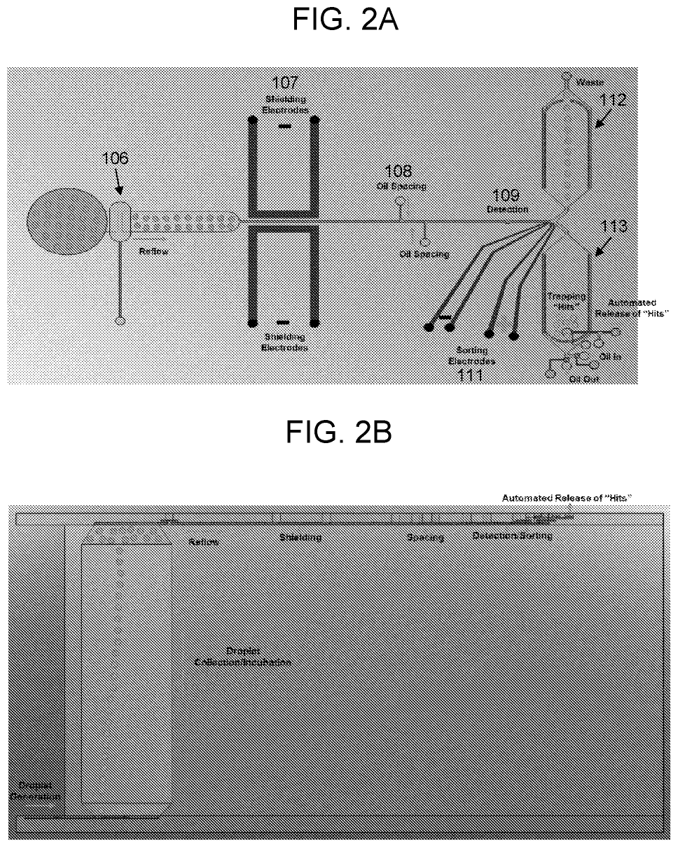

FIG. 1 is a 3D schematic illustration of an integrated droplet microfluidic platform according to an embodiment of the present disclosure. The integrated droplet microfluidic platform may include a plurality of substrate layers. The substrate layers may include 5 to 20 layers, and each layer may be made of at least one of various polymers and hard materials such as poly dimethyl siloxane (PDMS), thermoplastic, silica, poly(methyl methacrylate) (PMMA), glass or silicon. A plurality of functional components may be fabricated into the substrate layers. The functional components may comprise at least one co-flow based droplet generator for generation of cell or reagent-encapsulated droplets; at least one droplet incubation chamber for incubation of the cell or reagent-encapsulated droplets; at least one valve for trapping or releasing the droplets; a droplet detection mechanism; a sorting mechanism for sorting the droplets based on the detection result, and at least one droplet passage to interconnect at least one of the functional components. As illustrated in FIG. 1, the droplet microfluidic platform 100 includes a droplet generator 101 configured to continuously generate a cell or reagent-encapsulated droplets. The droplet generator 101 may include a co-flow based droplet generator 102. The droplet generator 101 further include a valve 103 configured to stop droplet generation in response to a control instruction. The droplet microfluidic platform 100 further includes an excess oil outlet and valve 104 that is configured to control oil release and drain excess oil out of the droplet microfluidic platform. The droplet microfluidic platform 100 also includes a droplet incubation chamber 105 for incubation of the cell or reagent-encapsulated droplets. The droplet incubation chamber 105 may have a cylinder shape, a cubic shape or any other desirable shape. The droplet generator 101, the generator valve 103 and the excess oil outlet and valve 104 are provided at a bottom substrate under the bottom of the droplet incubation chamber 105. The droplet generator 101, the generator valve 103 and the excess oil outlet and valve 104 are coupled to the bottom of the droplet incubation chamber 105. The droplet microfluidic platform 100 further includes a valve 106, shielding electrodes 107, an oil inlet spacing 108, a droplet detection mechanism 109, a sorting mechanism 110, a waste channel 112 and a basket trapping portion 113. The valve 106, the shielding electrodes 107, the oil inlet spacing 108, the droplet detection mechanism 109, the sorting mechanism 110, the waste channel 112 and the basket trapping portion 113 are provided in a top substrate on the top of the droplet incubation chamber 105. The valve 106 is configured to trap or release the droplets collected in the droplet incubation chamber 105. The shielding electrodes are provided along the flow path of the droplets between the valve 106 and the oil inlet spacing 108 or between the valve 106 and the droplet detection mechanism 109. The droplet detection mechanism 109 may include a laser light device and a detector. The droplet detection mechanism 109 is configured to detect the droplets based on at least one of fluorescent, colorimetric, dielectric, conductivity or vibrational spectroscopy signals. The sorting mechanism 110 includes at least a pair of sorting electrodes 111 and is configured to sort the droplets based on the detection result from the droplet detection mechanism 109 as illustrated in FIGS. 2A and 2B. The sorted droplets are then trapped in the basket trapping portion 113 on the droplet microfluidic platform 100 and reflowed using an automated droplet recovery process for post-processing of the hit droplets. The droplet microfluidic platform 100 may further include a functional component for on-chip recovery of sorted droplets. For example, the automated droplet recovery process can be performed by an automated droplet release portion 114 including an on-chip recovery of hit droplets as illustrated in FIG. 1. The droplet microfluidic platform 100 may further include an oil outlet and oil inlet valves portion 115 to reflow or release the oil. The droplet microfluidic platform 100 may include but not limited to 9 substrate layers. The droplet microfluidic platform 100 is capable of continuous or semi-continuous on-chip operation of droplets in a first-in first-out manner.

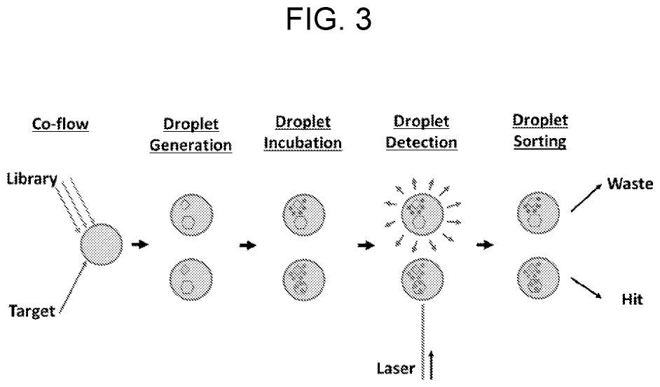

FIG. 3 is a schematic workflow of a screening assay to be performed on the integrated droplet microfluidic platform according to an embodiment of the present disclosure. For example, when consider an environmental library-based droplet screening approach, environmental organisms from the environmental library are co-encapsulated with a GFP target organism in a water-in-oil emulsion to probe their interactions and measure how the environmental cells affect the target organism. After co-incubation in a large scale droplet culture chamber, droplets are reflowed for downstream fluorescent-based detection, followed by electric field droplet sorting based on the observed interactions. The sorted hit droplets are trapped on-chip (the integrated droplet microfluidic platform) and reflowed using an automated droplet recovery process for post-processing of the hit droplets.

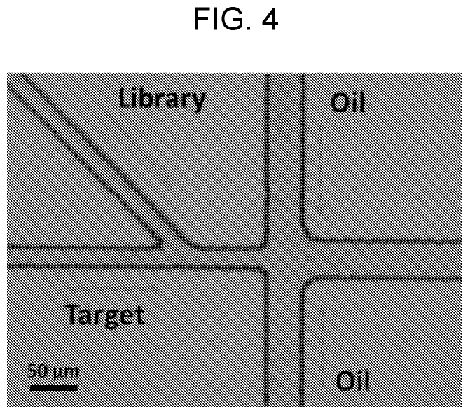

FIG. 4 is a micrograph illustrating a Y-shape droplet generator for co-flow and a cross junction droplet generator for encapsulation of two fluids simultaneously according to an embodiment of the present disclosure. For example, a droplet is first generated using Y-shape junction from two co-flow streams, followed by a t-junction, cross-junction or flow-focusing nozzle to co-encapsulate cells, reagents, or compounds (oil) into a microdroplet. This specification structure has technical advantages such as removing the need for downstream droplet generation, synchronization and merging.

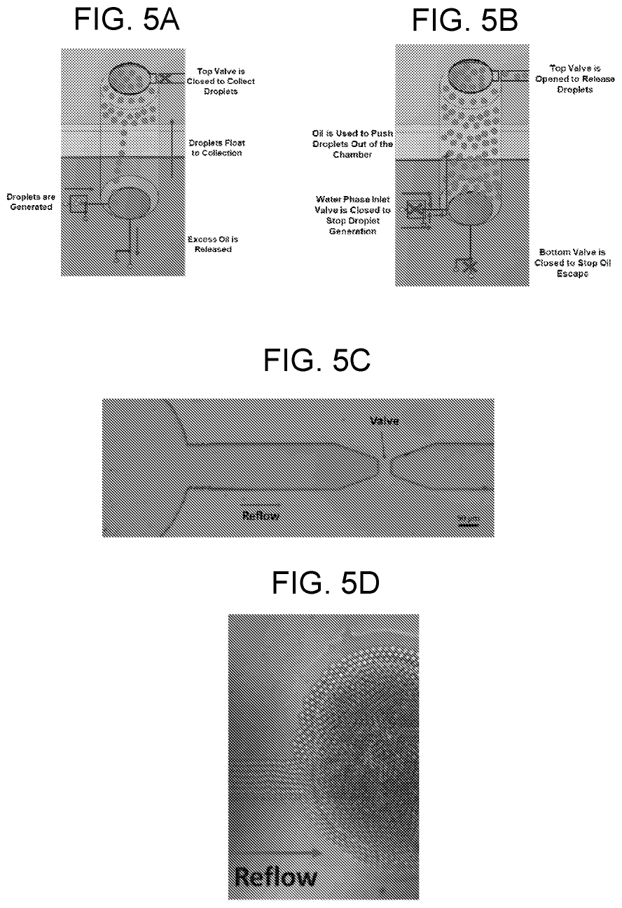

FIG. 5A is a 2D schematic illustration of a large-scale culture chamber when a top micro-valve is closed; and FIG. 5B is a 2D schematic illustration of a large-scale culture chamber when the top micro-valve is opened. As illustrated in FIGS. 5A and 5B, a large-scale culture chamber with a bottom and a top micro-valves is utilized to house the generated droplets in a first-in first-out format providing identical culture durations for all droplets. While droplets are being generated, the top micro-valve is closed and the bottom micro-valve is opened. Due to the buoyance of the droplets, droplets enter the large-scale chamber from the bottom and float to the top, filling the droplet culture chamber. Excess oil is allowed to escape or release from the bottom valve outlet, leading to the large-scale culture chamber filled with packed droplets.

FIG. 5C is a micrograph illustrating an integrated valve for control of flow into, through, and out of the culture chamber; and FIG. 5D is a micrograph illustrating droplets being reflowed in a packed controlled format for optimal downstream operation according to an embodiment of the present disclosure. After co-incubation of cells in the droplets for a desired duration, the top micro-valve is opened while the bottom micro-valve is simultaneously closed, transitioning droplets out of the top of the culture chamber in a tightly packed manner as illustrated in FIG. 5D.

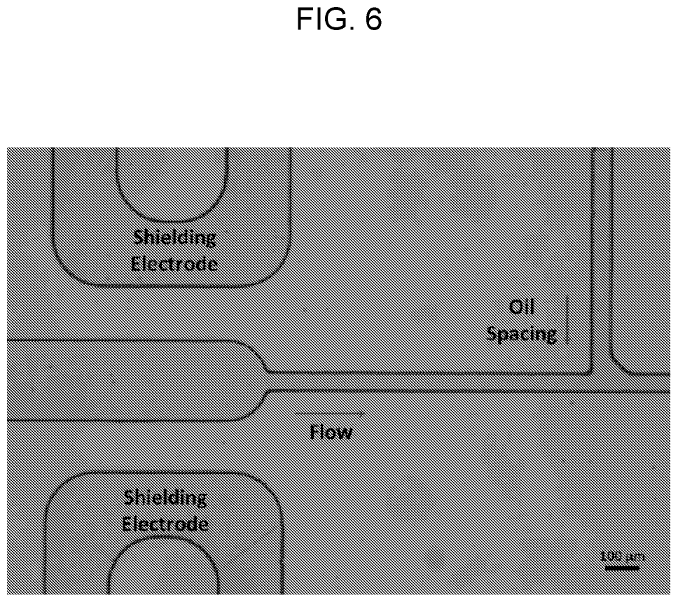

FIG. 6 is a micrograph illustrating an adjacent droplet spacer channel injecting oil into the system to space droplets before downstream processing according to an embodiment of the present disclosure. When the droplets pass through the shielding electrodes, a much higher oil inlet flow is used to space droplets in preparation for downstream detection and sorting.

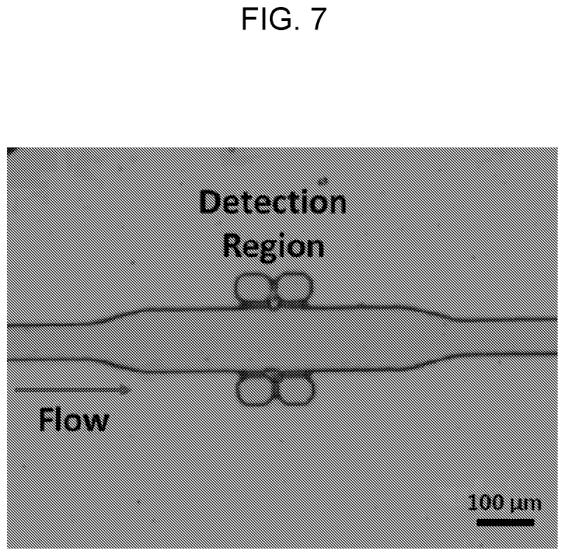

FIG. 7 is a micrograph illustrating a droplet detection mechanism for on-the-fly whole droplet detection according to an embodiment of the present disclosure. The droplet detection mechanism may include a laser light device, a detector or the like. The droplet detection mechanism is configured to detect the droplets based on at least one of fluorescent, colorimetric, dielectric, conductivity or vibrational spectroscopy signals.

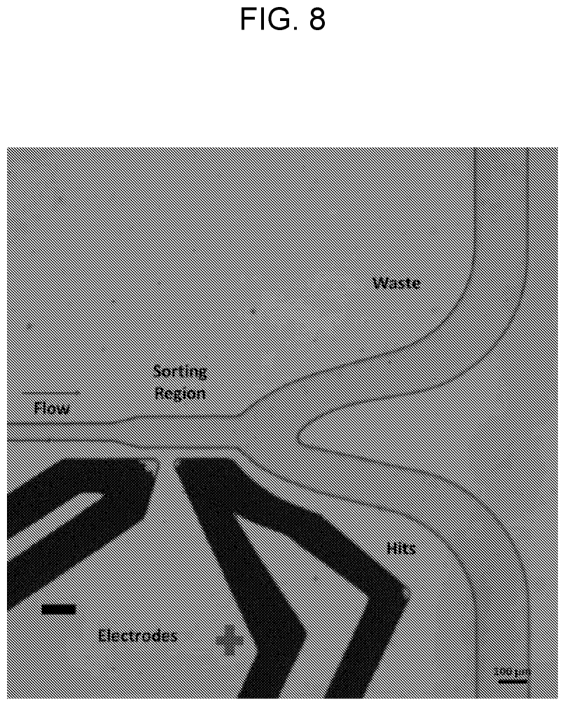

FIG. 8 is a micrograph illustrating a droplet sorting region where one outlet goes to waste, and an adjacent outlet is used to collect “hits” of interest according to an embodiment of the present disclosure. A sorting mechanism includes at least a pair of electrodes configured to general electrical field to sort the droplets passing through the sorting region. The flow path is split up into a branch. The sorting mechanism is provided on the same side as a droplet trapping chamber that collects the hit droplets.

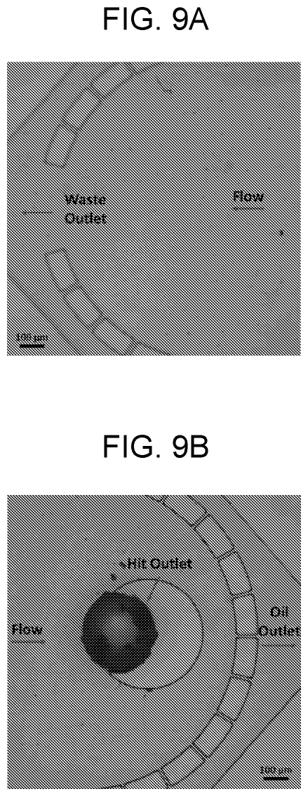

FIG. 9A is a micrograph illustrating a waste basket for equal fluid resistance according to an embodiment of the present disclosure; and FIG. 9B is a micrograph illustrating a basket trapping structure to collect droplets of interest according to an embodiment of the present disclosure. Pillar-based basket-like droplet trapping chambers are coupled to the outlet of the waste channel and outlet of the “hit” channel, providing identical fluidic resistance to each of the outlets. As illustrated in FIG. 9A, the waste basket has missing pillars at the end to allow free flow of waste droplets of the droplet microfluidic platform. On the other hand, the “hit” basket has one outlet at the middle-end of the basket structure/trapping that traps sorted droplets and traverses them vertically to an additional layer with a top valve. A second outlet at the back of the pillar-based basket structure/trapping allows for removal of excess oil while the “hit droplets” are packed inside the basket structure/trapping.

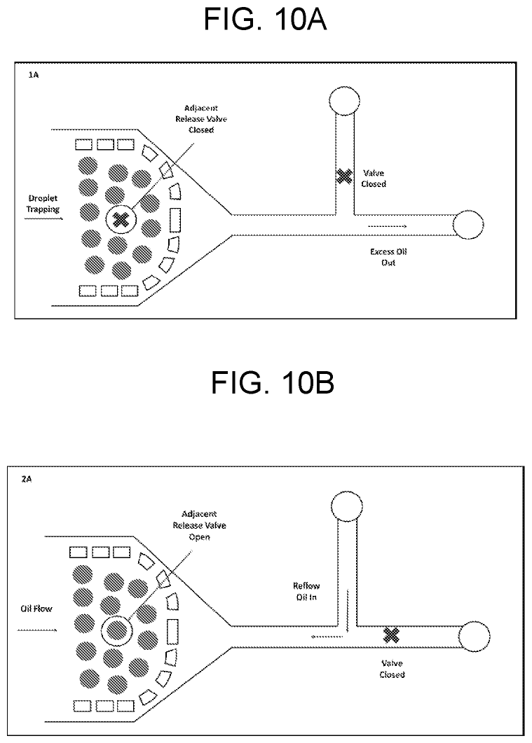

FIG. 10A is a schematic illustration of a process for automatic trapping of hit droplets; and FIG. 10B is a schematic illustration of a process for automatic release of hit droplets according to an embodiment of the present disclosure. When the hit droplets are ready to be recovered, an additional set of valves simultaneously close the oil outlet, open the top valve and open an additional adjacent channel used to inject oil from the back of the chamber. This pushes droplets from the back and front of the chamber and out through the top of the chamber to the adjacent layers. The top layer entails an additional oil injection inlet to space droplets so that they can be dispensed into wells of a multi-well plates (one droplet in one well) or on agar plates with sufficient distances so that single colonies can be recovered. This process allows for the automated trapping and release of the hit droplets for further downstream processing.

According to an embodiment of the present disclosure, the droplet size and throughput can be easily tuned to standardize the system. Coupled with downstream droplet detection and sorting, high sampling rate data acquisition (DAQ) and sorting functionalities can easily be characterized to appropriately match the droplet generation and reflow conditions. The systems and/or devices are easily characterized and capable of conducting library screening with desired conditions.

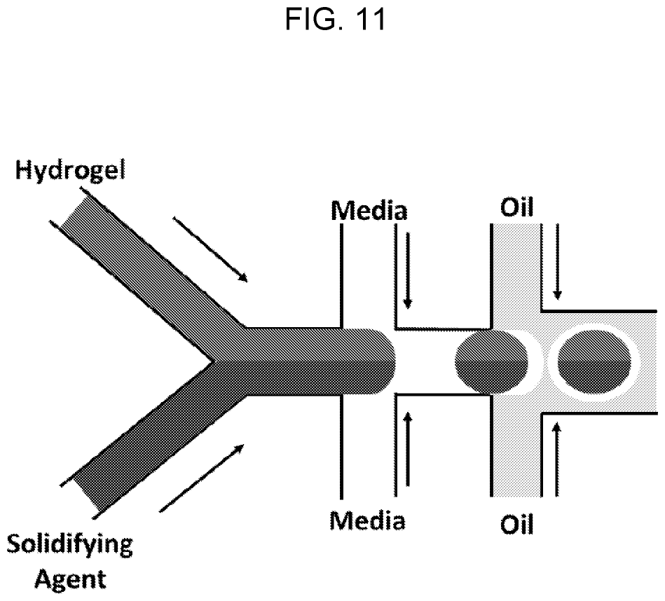

FIG. 11 is a schematic illustration of a core-shell droplet that can be generated using co-flow and multi-emulsion to include droplet merging without any separate merging functionalities according to an embodiment of the present disclosure. For example, aqueous droplets that are generated for con-encapsulation of environmental cells and target cells can include multiple variations of multi-emulsion or core-shell structures. The co-flow scheme can be used to encapsulate, but not limited to, biochemical reagents, beads, particles, or gel droplets, which can be later released prior to, or after, droplet detection and sorting. This scheme can lead to the generation of a double emulsion (or more, i.e. triple, quadruple, core/shell, multicore, etc.) droplet that is released or merged using downstream processes such as, but not limited to, chemical treatment, electrical treatment, or temperature adjustment. In an embodiment, a multi-emulsion process is used to generate droplets including at least one of gel droplets, double emulsion, core-shell structures, multi-core-shell structures, particles, beads, reagents, biochemical compounds, or fluid phases.

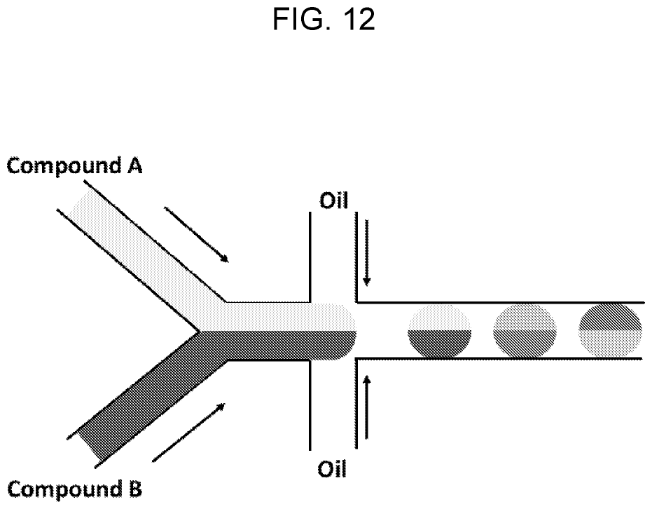

FIG. 12 is a schematic illustration of a co-flow ratio gradient generator for screening of different concentrations or combination concentrations according to an embodiment of the present disclosure. The co-flow ratio gradient generator scheme as illustrated in FIG. 12 can achieve different droplet reagent ratios. For example, the co-flow ratio gradient generator scheme entails the change in co-flow ratios to generate varying concentrations of, but not limited to, biochemical reagents, cells, beads, particles, or gel solidifying reagents. The co-flow ratio conditions can be set for a given experiment providing an assay with a standard condition that can be repeated with different conditions for each run. Alternatively, the co-flow rates can be varied over time in a given experiment, providing a gradient of conditions with respect to time. In another embodiment, a gradient droplet generator is coupled to the droplet microfluidic platform as described above to generate encapsulated droplets comprising a gradient of a compound or the target cell.

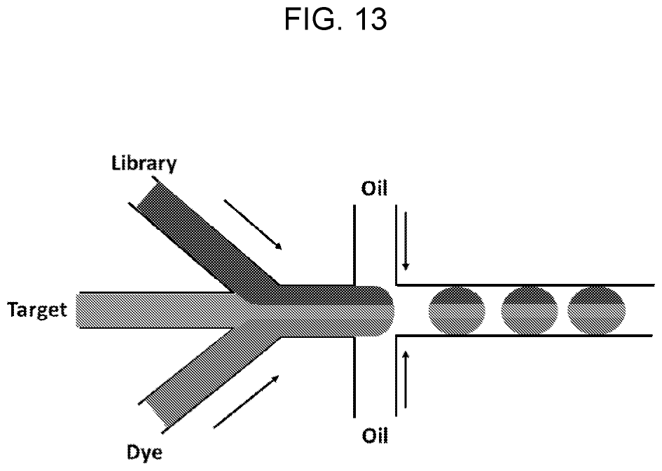

FIG. 13 is a schematic illustration of a triple flow scheme for including dye-staining with ability to include other quad- (or more) co-flow or multi-emulsion schemes for encapsulating multiple fluids according to an embodiment of the present disclosure. The triple flow scheme can achieve addition of droplet dye staining. For example, the triple flow scheme includes a multi-mixture, triple co-flow (or more), and/or the addition of dye staining, tagging, adherence mechanisms (or other detection methods) to generate droplets containing, but not limited to, multiple reagents or cells.

According to an embodiment of the present disclosure, the integrative stacking of the droplet culture chamber layers provide the ability to create a droplet incubation chamber of the desired volume with no limitations. In another embodiment, the microfluidic platform may comprise a sandwich multiplexed design, and at least two droplet culture incubation chambers are in the same horizontal plane. A multiplexed incubation chamber scheme including two or more culture incubation chambers can be used in an embodiment. Layers are stacked by aligning adjacent layers using 3D alignment and photolithography-based alignment marks. Front and backside alignment marks are imprinted on each layer to allow for precise alignment between layers during the bonding and assembly processes.

According to an embodiment of the present disclosure, the fabrication process may include the use of photolithography-patterned alignment marks and 3D printed 3D alignment marks to stack complex multilayer devices with high aspect ratio structures to create a functional droplet microfluidic screening system. This method uses 3D printed, milled, two-photon photolithography (2PP), or machined microfluidic layers with front and backside alignment to create a network of integrated channels for conducting complex assays. The sloped droplet transition layers used to move droplets to adjacent layers use a microfabrication process called two-photon photolithography (2PP). This microfabrication technology uses a direct laser writing method, which takes advantage of two near-IR photons to induce polymerization of a photosensitive material. The femtosecond laser scanning results in a 3D volume being affected whose feature sizes can be in the range of a few tens of nanometers to several (or several tens of) micrometers. This allows for the production of microstructures where their dimensions (e.g., height) can change in the vertical direction (height direction) to create complex microfluidic channel structures.

According to an embodiment of the present disclosure, the droplet microfluidic platform is fabricated as a single injection molded piece. In another embodiment, the droplet microfluidic platform may include multiple injection molded pieces that are stacked and bonded together.

According to an embodiment of the present disclosure, the bottom outlet of the droplet culture chamber also serves as an overflow protection system and continuous perfusion system for the droplet incubation chamber. For instance, when the chamber is filled with droplets the environmental cell and target cell inlet flows can be stopped using a valve, but oil can continue to flow, essentially halting droplet generation and providing continuous perfusion to the trapped droplets in the chamber.

Furthermore, the reflow speed can be easily adjusted and tuned to the desired reflow rate and allow for stabilization of flow well in advance of droplet reflow. This leads to a stable pressure in the droplet microfluidic platform or system prior to droplet reflow and more efficient and uniform reflow of droplets.

According to an embodiment of the present disclosure, a method of making or producing a highly aligned multilayered droplet microfluidic platform and/or system is provided. The method comprises casting 5 to 20 individual polydimethylsiloxane (PDMS) layers from a master mold; bonding the individual polydimethylsiloxane layers into a single structure utilizing corresponding integrated alignment marks imbedded into each layer, the single structure comprising fluid passages and functional components between adjacent layers. The droplet microfluidic platform is capable of continuous or semi-continuous on-chip operation of droplets through a sequence of functional components in a first-in first-out manner.

According to another embodiment of the present disclosure, a method of making or producing a highly aligned multilayered droplet microfluidic platform and/or system is provided. The method comprises injection molding multiple layers of the platform as individual pieces; bonding the individual pieces into a single structure comprising fluid passages and functional components between adjacent layers. The droplet microfluidic platform is capable of continuous or semi-continuous on-chip operation of droplets through a sequence of functional components in a first-in first-out manner.

According to yet another embodiment of the present disclosure, a method of making or producing a droplet microfluidic platform and/or system is provided. The method comprises injection molding the platform design into a single component. The droplet microfluidic platform is capable of continuous or semi-continuous on-chip operation of droplets through a sequence of functional components in a first-in first-out manner.

According to an embodiment of the present disclosure, a method for identifying cell-produced molecules affecting a target cell utilizing a multilayered droplet microfluidic platform and/or system is provided. The method comprises generating continuously a large number of cell-encapsulated droplets comprising a target cell (or cells) and a library cell that is a potential producer of molecules capable of affecting the target cell; co-incubation of both cell types for a certain period of time for the production of molecules by the library cell to influence the target cell; analyzing the cell-encapsulated droplets using an on-chip detection mechanism; sorting the cell-encapsulated droplets that show effect of interest on the target cell; and recovering the sorted cell-encapsulated droplets of interest. The on-chip analysis of the cell-encapsulated droplets may be based on at least one of the followings: determining expression or function of a nucleic acid or protein; analyzing growth rate, death, necrosis or apoptosis of the target cell; and evaluating metabolic activity or production of metabolic products. However, in another embodiment, the on-chip analysis of cell-encapsulated droplets may be based on at least one of fluorescent, colorimetric, dielectric, conductivity, or vibrational spectroscopy signals. During the process of identifying cell-produced molecules affecting a target cell using the multilayered droplet microfluidic platform, at least one of the followings is detected and sorted based on: target cell death, reduction in target cell growth compared to normal growth, increase in target cell growth compared to normal growth, activation of nucleic acid expression, and suppression of nucleic acid expression, activation of protein expression, suppression of protein expression, activation of metabolic product expression, or suppression of metabolic product expression.

The target cell may comprise at least one selected from the group consisting of eukaryotic cells, bacterial cells, archaeal cells, pathogens, commensal organisms, microbes, mammalian cells, and insect cells. The libraries to be screened comprise at least one selected from the group consisting of environmental microbes, synthetic libraries of microbes that produce diverse small molecules, and microbiota. The synthetic libraries may include a polyketide expression library in an embodiment.

The present disclosure provides methods for conducting the overall screening assay that entails the full integration of a co-flow droplet generation system, modular droplet incubation chambers, transition of droplets from the culture chamber to a detection region, and on-the-fly electric field-based droplet sorting. The integration of valve operations at each stage of the system, together with a computer-controlled interface, allows for the methods to automatically conduct screening assays and retrieve “hit droplets” of interest without human interaction.

The present disclosure provides systems, devices and methods for integrating, automating, and achieving ultra-high efficiency (above 99.9%) droplet screening. The present technology reduces error rate (i.e., false positive and/or false negative), increases overall platform efficiency, reduces the time/cost to conduct an assay, and reduces the required time to acquire a hit droplet of interest. Additionally, the system offers the versatility to perform ratio-based and gradient-based screening assays on a mass-scale with high repeatability.

It should be understood that the effects described herein are mere examples, and effects of the technology are therefore not limited to those described herein. Accordingly, the present technology may achieve any other effect.

It should also be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A droplet microfluidic platform, including:
a plurality of substrate layers into which various functional components are fabricated into, the functional components including
at least one co-flow based droplet generator for continuous generation of cell or reagent-encapsulated droplets;
at least one droplet incubation chamber for incubation of the cell or reagent-encapsulated droplets;
at least one valve for trapping or releasing the droplets;
a droplet detection mechanism;
a sorting mechanism for sorting the droplets based on the detection result, and at least one droplet passage to interconnect the functional components; wherein the droplet microfluidic platform is capable of continuous or semi-continuous on-chip operation of droplets in a first-in first-out manner.

2. The droplet microfluidic platform of claim 1, further comprising a functional component for on-chip recovery of sorted droplets.

3. The droplet microfluidic platform of claim 1, wherein the droplet detection mechanism is configured to detect at least one of optical, dielectric, conductivity, or vibrational spectroscopy signals.

4. The droplet microfluidic platform of claim 1, wherein the substrate layers comprises 5 to 20 layers.

5. The droplet microfluidic platform of claim 1, wherein the droplet microfluidic platform is fabricated as a single injection molded piece.

6. The droplet microfluidic platform of claim 1, wherein the droplet microfluidic platform includes multiple injection molded pieces that are stacked and bonded together.

7. The droplet microfluidic platform of claim 1, wherein the droplet microfluidic platform comprises a sandwich multiplexed design, and wherein at least two droplet incubation chambers are in the same horizontal plane.

8. A method of making a droplet microfluidic platform, comprising: casting 5 to 20 individual polydimethylsiloxane (PDMS) layers from a master mold;
bonding the individual polydimethylsiloxane layers into a single structure utilizing corresponding integrated alignment marks imbedded into each layer, the single structure comprising fluid passages and functional components between adjacent layers; and
wherein the droplet microfluidic platform is capable of continuous or semi-continuous on-chip operation of droplets through a sequence of functional components in a first-in first-out manner.

9. A method of producing the droplet microfluidic platform of claim 1 comprising:
injection molding multiple layers of the platform as individual pieces; bonding the individual pieces into a single structure comprising fluid passages and functional components between adjacent layers; and
wherein the droplet microfluidic platform is capable of continuous or semi-continuous on-chip operation of droplets through a sequence of functional components in a first-in first-out manner.

10. A method of producing the droplet microfluidic platform of claim 1 comprising:
injection molding the platform design into a single component; and
wherein the droplet microfluidic platform is capable of continuous or semi-continuous on-chip operation of droplets through a sequence of functional components in a first-in first-out manner.

11. A method for identifying cell-produced molecules affecting a target cell utilizing the droplet microfluidic platform of claim 1, comprising:
generating continuously a large number of cell-encapsulated droplets comprising a target cell and a library cell that is a potential producer of molecules capable of affecting the target cell;
co-incubation of both cell types for a certain period of time for the production of molecules by the library cell to influence the target cell;
analyzing the cell-encapsulated droplets using an on-chip detection mechanism;
sorting the cell-encapsulated droplets that show effect of interest on the target cell; and recovering the sorted cell-encapsulated droplets of interest.

12. The method of claim 11, wherein on-chip analysis of the cell-encapsulated droplets is based on at least one of the following:
determining expression or function of a nucleic acid or protein;
analyzing growth rate, death, necrosis or apoptosis of the target cell; and evaluating metabolic activity or production of metabolic products.

13. The method of claim 11, wherein on-chip analysis of cell-encapsulated droplets is based on at least one of fluorescent, colorimetric, dielectric, conductivity, or vibrational spectroscopy signals.

14. The method of claim 12, wherein at least one of the following is detected and sorted based on:
target cell death, reduction in target cell growth compared to normal growth, increase in target cell growth compared to normal growth, activation of nucleic acid expression,
suppression of nucleic acid expression, activation of protein expression, suppression of protein expression, activation of metabolic product expression, or suppression of metabolic product expression.

15. The method of claim 11, wherein the target cell comprises at least one selected from the group consisting of eukaryotic cells, bacterial cells, archaeal cells, pathogens, commensal organisms, microbes, mammalian cells, and insect cells.

16. The method of claim 11, wherein libraries to be screened comprise at least one selected from the group consisting of environmental microbes, synthetic libraries of microbes that produce diverse small molecules, and microbiota.

17. The method of claim 16, wherein the synthetic libraries include a polyketide expression library.

18. The method of claim 11, wherein a multiplexed incubation chamber scheme is used.

19. The method of claim 11, wherein a multi-emulsion process is used to generate droplets including at least one of gel droplets, double emulsion, core-shell structures, multi-core-shell structures, particles, beads, reagents, biochemical compounds, or fluid phases.

20. The method of claim 11, wherein a gradient droplet generator is coupled to the droplet microfluidic platform to generate encapsulated droplets comprising a gradient of a compound or the target cell.
